(19) United States
(12) Patent Application Publication
(10) Pub. No.: US 2009/0302508 A1
(43) Pub. Date: Dec. 10, 2009

(54) METHOD OF CONSTRUCTION

(76) Inventors: Christopher Francis Lucas, Hamilton (NZ); Jeffrey John Sharp, Hamilton (NZ)

Correspondence Address: GREER, BURNS & CRAIN, 300 S WACKER DR, 25TH FLOOR, CHICAGO, IL, 60606, US

(21) Appl. No.: 12/066,363

(22) PCT Filed: Nov. 6, 2006
(86) PCT No.: PCT/NZ06/00284

§ 371 Date: Jul. 31, 2008

(30) Foreign Application Priority Data
Nov. 7, 2005 (NZ) 542334

(51) Int. Cl. B29C 45/17

(52) U.S. Cl. 264/500

(57) ABSTRACT

A method of producing a one-piece support structure which incorporates a supporting platform and at least one integral support leg using a blow moulding technique, including the steps of: a) defining the optimum thickness of material required for the support leg(s) for strength purposes, b) defining the optimum height for the support legs, c) determining the volume of the parison, to be introduced across the leg part of the mould, d) designing the mould leg interior to ensure that for the given parison volume the thickness of material subsequently blow moulded around the surface area of the support leg is sufficient to provide the required strength, and e) blow moulding material into the mould as designed by steps a) to d).

### TECHNICAL FIELD

The present invention relates to a method for construction of a support surface such as a pallet.

### BACKGROUND ART

Products used to transfer various kinds of goods are well known in the art. Pallets in the past have usually been made of wood, and include slots on opposing sides configured to receive forklift tines. The pallets are then stably balanced on the tines, the tines raised and the goods secured to the pallets may then be transferred of moved as desired.

In recent times, pallets have been manufactured from other materials such as plastics. Plastic pallets often cost more to manufacture, but have a longer life expectancy than wooden pallets. Plastic pallets are also much easier to clean or sterilise to a standard required for the transfer or movement of some food products.

There are three major ways of moulding plastic which are well known in the art, being injection moulding, rotational moulding and blow moulding.

With injection moulding, there is provided a mould into which molten plastic is injected under pressure. The cost of producing a mould of a size of a pallet would be extremely expensive. However, of more importance is that there is only a limited number of injection moulding machines that actually have the capability to apply sufficient force to hold a pallet sized mould together when it is being injected with fluid plastic material under pressure. Although injection moulding can result in high production rates, the extremely high expense of both the mould and the machinery required to injection mould same is prohibitive when compared to other moulding techniques.

An alternative method of plastic moulding is rotational moulding which requires less expensive machinery than injection moulding. Rotational moulding has been used by the current applicants to produce pallets, for example WO 95/00064, specifically by manufacturing two pallet halves and then joining these together to create a complete pallet. Creating the pallet in two halves overcomes one of the problems with the rotational moulding, being the need to include internal ‘cores’ which can be removed after moulding to provide the holes into which the tines of the forklift can be positioned.

However problems with rotational moulding include slow production rates as plastic beads/granules have to be introduced into each mould which is then rotated above a heat source to melt the beads and form a plastic skin around the outside of the mould.

Rotational moulding is useful for moulding of pallets in that there is a natural tendency to get an increased thickness into the corners of the pallet due to the rotational movement around two axis, thereby providing the required strength at the corners of the pallet. This is hard to achieve with either injection or blow moulding.

Blow moulding is a further process of moulding plastic including the general process of the plastic being feed in granular form into a storage unit. The granules are then fed through a heated section, resulting in the granules melting to become a hollow plastic melt tube extruded from the die head of a blow moulding machine known as a parison. This is then fed into the mould. Air is then forced into the parison which forces the plastic to the sides giving the shape of the mould. The mould is then cooled and removed.

Blow moulding has previously been used to produce symmetrical objects such as bottles or floats. This is due to the fact that it provides an even thickness of plastic around the interior of the whole mould.

Blow moulding is not traditionally used to manufacture asymmetrical products which require differing areas of thickness.

Blow moulding has however, previously been used to produce pallets of a differing design, which have a symmetrical structure and no integral legs. Integral legs are important as they provide spaces for forklift tines to be inserted for movement of the pallet.

But blow moulding has not previously been used to produce plastic pallets which include integral legs, as these require increased strength and thickness of plastic at the corners in order to maintain their integrity during movement and transport. Increasing the thickness of the plastic throughout the entire mould to provide this strength would be too expensive. Integral legs are preferred as they provide greater stability and strength to the pallet, and allow easy cleaning of same.

Blow moulding however has the significant advantages over both injection moulding in that it is much less expensive and rotary moulding in that you have a much higher production rate.

It would be beneficial in the production of support structures such as plastic pallets incorporating integral legs if there was a process whereby blow moulding could be used to produce same.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a method of creating a support structure which incorporates a supporting platform and at least one integral support leg using a blow moulding technique, including the steps of:
a) defining the optimum thickness of material required for the support leg(s) for strength purposes,
b) defining the optimum height for the support legs,
c) determining the volume of the parison, to be introduced across the leg part of the mould,
d) designing the mould leg interior to ensure that for the given parison volume the thickness of material subsequently blow moulded around the surface area of the support leg is sufficient to provide the required strength.

In a preferred embodiment the support structure may be a pallet, and shall be referred to as such herein. However this should not be seen as limiting as any other support structure requiring integral legs may be created via this method.

In a preferred embodiment the pallet may be made of plastic, and shall be referred to as such herein. In most preferable embodiments the plastic may be high density polyethylene. However this should not be seen as limiting as other types of plastic may be used.

If a strong plastic is used, less volume is required and a lighter pallet results, but the plastic itself is more expensive per kilogram. A weaker plastic, although cheaper per kilogram, requires a greater volume and results in a pallet of greater weight.

In one embodiment the pallet may be formed in one piece, having a support surface with legs depending downwards.

In an alternative embodiment the pallet may include a further support surface attached across the legs, such as a strip or strips of material or a solid surface. These surfaces can be made of any suitable material, for example wood.

In one particularly preferred embodiment the pallet may be manufactured in two pieces, being complementary halves to each other, and which can then have the integral support legs joined to form a complete pallet, referred to herein as a ‘two piece pallet’. Reference throughout this specification will now be made to two piece pallets, unless otherwise specified.

It should be appreciated that both halves of a two piece pallet will include a supporting platform and at least one supporting leg.

In a preferred embodiment the two complementary halves of the two piece pallet may be identical, and shall be referred to as such herein. This provides the significant advantage that the same mould can be used to produce both halves. This decreases the cost of producing moulds, and complexity of same. However, this should not be seen as limiting, as in some situations two piece pallets wherein the two halves are not identical may be desired.

In preferred embodiments the two piece pallet may be permanently joined together, for example by adhesive. However this should not be seen as limiting as detachable pallet pieces, joined (for example by bolts) may be produced in order to decrease storage space when not in use.

In most preferable embodiments the pallet, or pallet half in the case of a two piece pallet may consist of a platform and at least three to twelve integral legs. The integral legs allow attachment of the two pallet pieces to each other and provide spaces between the legs through which the tines of a forklift can be positioned underneath the supporting platform to allow lifting and transport of the pallet. In a preferred embodiment the supporting legs may be positioned such that the forklift tines may be inserted from any one of the four sides of the pallet. In a one piece pallet, the integral support legs, act in the same manner to allow pallets to be lifted by forklift tines and stacked or moved as desired.

Blow moulding has not previously been used to produce asymmetrical plastic pallets as described in the current application. This is due to the variability of plastic thickness in an asymmetrical mould is not easy to control. The pallets of the present invention require increased strength and thickness of plastic at the corners in order to maintain their integrity during movement and transport. Blow moulding however usually results in a fairly even coating of plastic over the mould.

The present invention allows the shape of the mould to be designed to allow blow moulding of a pallet and pallet pieces that result in sufficient strength at the corners and around the leg areas.

This is due to a greater thickness of plastic being applied in these areas during the blow moulding as a consequence of considering the leg surface area of the mould to parison volume.

In preferred embodiments the optimum thickness of material for the support legs may be that which provides sufficient strength to the leg in the finished pallet for the volume of plastic introduced through the parison.

It is envisaged that in some embodiments the pallet interior may be filled with a secondary material. In a preferred embodiment the secondary material may be foam, for example with polyurethane. Therefore the thickness of material for the support legs may also vary according to the supporting strength of the secondary material or foam.

In a preferred embodiment the optimum thickness of plastic for the support legs may be within the range of 1 to 10 millimeters for a pallet required to hold in the order of 1000 kilograms in a racking situation. In most preferable embodiments the thickness of plastic may be of a polyurethane foam filled pallet made from polyethylene will be in the order of 1 to 6 millimetres.

In a preferred embodiment the height of the integral legs relative to the supporting platform may be sufficient to allow at least one forklift tine to be positioned between same, under the supporting platform.

In a preferred embodiment the optimum height of the support legs for a single pallet piece may be within the range of 100 to 150 millimetres in order to accommodate forklift tines between the support legs which can be used to lift the pallet. In a most preferable embodiment the height of the support leg may be 110 millimetres.

In a preferred embodiment the optimum height of the support legs for a two piece pallet may be approximately 75 to 150 millimetres. This is when the two halves are joined together. If the two halves are equal, this would mean a leg height of approximately 37 to 75 millimetres.

In a preferred embodiment the optimum support leg height is proportional to the height of the platform of which it is an integral part.

In a preferred embodiment the height of the integrated legs may be within the range of 100% to 300% of the height of the supporting platform.

The blow moulded thermoplastic pallet of the present invention is preferably constructed from one hollow moulding with a thin plastic skin that forms the top and bottom face of the pallet platform, the underside face of the platform has 4 to 12 integrated feet protrusions that form a space for a fork hoist forks,

In a preferred embodiment the width at the base of the feet, distal to the supporting platform may be between 100% and 650% of the height of the integral supporting legs.

In a preferred embodiment the depth of the base of the feet, distal to the supporting platform may be between 100% and 650% of the height of the integral supporting legs.

In a preferred embodiment the legs may be substantially square or rectangular in shape.

In some situations, depending on the leg height it may be difficult to blow mould square corners in a mould. If legs are vertical in relation to the platform they have a much greater surface area, leading to more plastic being required to obtain the required thickness. If legs are angled inward to a narrower portion at the further end from the platform they will have a lower surface area. Therefore a greater thickness per surface area may be obtained. If the legs are angled too much however they will provide insufficient support and stability to the pallet.

In one embodiment the method of overcoming the difficulties in blow moulding corners in the support legs is to design the shape of the leg be such that the blow moulding will result in sufficient thickness of plastic over the entire surface area of a leg.

In some embodiments the integral support legs may be angled, such that the leg size or diameter at the integral join with the supporting platform is greater than the size or diameter at the end of the legs opposite the supporting platform. However, this should not be seen as limiting, as the applicants have found that with the present pallet design, and other requirements such as leg height and size considerations with respect to the platform height allow for vertical or near vertical legs to be successfully blow moulded.

However, in some alternative embodiments the legs may be angled, for example the legs may be angled up to approximately 30° to the vertical from the supporting platform rather than being a rectangular shape which may result in decreased strength.

The design of the pallet in the present invention acts to minimise the surface area of the leg for the optimum leg height, therefore leading to a maximum thickness of plastic being deposited.

In an alternative embodiment the method of overcoming the difficulties in blow moulding corners in the support legs may be overcome by altering the design of the mould parting line. The mould parting line is the interface where the two halves of the mould meet and therefore where the parison is cut off prior to blow moulding.

In most instances of blow moulding pallets the mould parting line passes midway through the supporting platform when viewed from the side, this allows each half the platform height to be blown symmetrically from the centre, and therefore to be of even thickness on either side. The mould parting line is usually consistent across the whole mould.

In order to have the supporting legs as close to vertical as possible in relation to the supporting platform and still obtain the required thickness to give sufficient strength to the leg the mould parting line can be designed so that while it still passes through the centre of the platform, where support legs are present the parting line deviates towards the base of the supporting leg distal to the supporting platform. This provides a parting line which is much more central to the height of the support leg, rather than central to the height of the platform where supporting legs are present.

This local deviation of the parting line in the vicinity of the supporting legs allows the plastic to be blow moulded more centrally within the support leg, therefore allowing a support leg with a greater height, or vertical sides to be blow moulded and still retain sufficient thickness to obtain the required strength.

In some embodiments the thickness of plastic deposited in the legs and corners during blow moulding may also be enhanced by varying the volume of the parison introducing liquid plastic to the mould.

In alternative embodiments obtaining the required thickness of material into the supporting legs may be a combination of one or more of the following: angle of supporting legs, deviation of parting line and parison volume.

In preferred embodiments the design of the pallet may also include ribbing to increase the strength of the pallet in the gaps between the supporting legs where the forklifts tines may or will be positioned to lift or transport the pallet. However this should not be seen as limiting as depending on the material used to blow mould the pallet, extra strength may not be required.

In a preferred embodiment each half of the two piece pallet may include at least one interlocking joining portion to increase the strength of the pallet halves being joined. This will also prevent any lateral movement during transport or movement of the pallet.

In most preferred embodiments the interlocking connection may be in the form of a male/female connection, however this should not be seen as limiting as any other interlocking shape structure which can be created by blow moulding may be used.

In preferred embodiments the two pieces of the two piece pallet may also be bolted together for increased strength.

In preferred embodiments the bottom of the pallet may also have apertures which are of a shape and size that can accommodate a pallet trolley, such as a Jiffy pallet trolley to move the pallet(s) for one location to another. As the two piece pallets are symmetrical, it should be appreciated, that both sides or supporting platforms may include apertures for this purpose. A Jiffy pallet trolley has tines similar to forklift tines; however these also incorporate wheels at regular intervals along their length. In order to move the pallet there must be apertures in the bottom of the pallet to allow the wheels (which can fit through the spaces between the legs) to be positioned.

In preferred embodiments the pallet may also include handholds. Preferably the handholds may be curved to allow comfortable lifting of the pallet, without causing any injury to the person involved.

In preferred embodiments at least one handhold may be positioned on all four sides of the pallet to allow lifting when the pallet is orientated in any direction, and allow easy access to same. However this should not be seen as limiting as the pallet may have hand holds only on two opposing sides of the pallet.

In preferred embodiments the handholds may be positioned on the outside top edge of the pallet edge, in order to allow the pallet to be easily lifted if required. However this should not be seen as limiting as the hand holds may be located in other positions. For example, as above, a two piece pallet may have handholds on both supporting platforms given the symmetrical nature of same.

Advantages of using a blow moulding technique as disclosed over other methods of moulding plastic include:
a higher production rate due to reduced time required to product each pallet or pallet piece,
The raw plastic material does not require an intermediately processing step before it can be used in order to create suitable plastic. For example beads can be used directly for blow moulding, whereas for rotational moulding the same beads would have to be crushed to a powder before use,
The design allows a Blow moulded plastic pallet to be made, which has sufficient plastic thickness in the supporting legs to provide the required strength,
The thickness of the material blown into the mould can be manipulated by changing the leg shape, the parting line and the parison volume,
Through the ability to manipulate the parison thickness blow moulding machines can make variable weight pallets using the same mould. This cannot be achieved with injection moulding.
Use of plastic and the design makes them easy to clean and/or sterilise.

### BRIEF DESCRIPTION OF DRAWINGS

Further aspects of the present invention will become apparent from the following description which is given by way of example only and with reference to the accompanying drawings in which:

FIG. 1 shows a schematic of two different types of pallet: a platform pallet (1A), a racking pallet (1B and 1C);

FIG. 2 shows a schematic of pallet leg including dimensions, and angles required to blow mould support legs with sufficient strength according to one aspect of the present invention; and

FIG. 3 shows a schematic of a parison and a cross section of a pallet design required to allow blow moulding of the pallet/pallet pieces according to one aspect of the present invention; and

FIG. 4 shows a top view of a pallet, indicating the position of the support legs according to one aspect of the present invention.

### BEST MODES FOR CARRYING OUT THE INVENTION

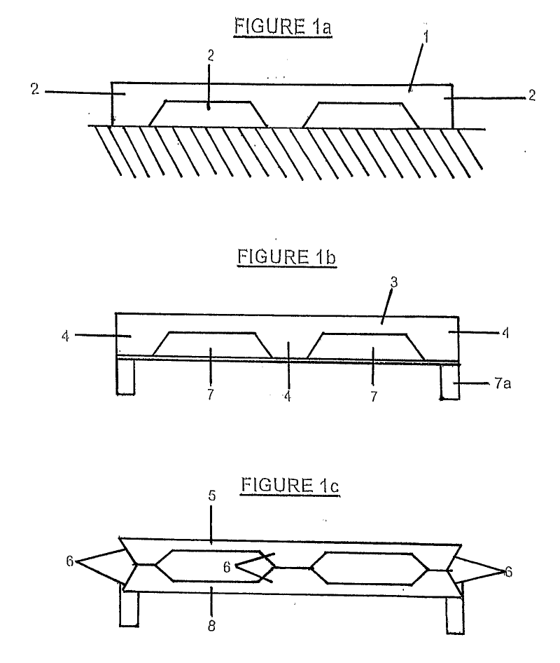

FIG. 1 shows the general shape of two main types of pallet commonly used.

FIG. 1A shows the vertical cross section of a platform pallet, this is a design that has a supporting platform (1) that is raised from the floor by a number of integral support legs (2), the gap formed by the legs between the underside of the platform and the ground, is the area that is used to lift the pallet by a fork hoist/lift or Jiffy trolley.

FIGS. 1B and 1C show two variations on the vertical cross section of a racking pallet, both these designs, like the platform pallet has a supporting platform (3) and (5) (respectively for FIGS. 1B and 1C) raised from the floor by a number of integral support legs (4) and (6) (respectively for FIGS. 1B and 1C).

FIG. 1B shows a number of apertures able to accommodate forklift tines (7) between the legs (4) and the floor (7a), whereas FIG. 1C shows a secondary platform (8), with apertures to accommodate forklift tines between the two platforms (5) and (8). This gives additional strength to the pallet, and thus the pallet which would be used where it need to be racked.

FIG. 1C provides an example of a ‘two piece pallet’ as herein described, whereas FIG. 1A provides an example of a ‘one piece pallet’.

The preferred type of pallet produced by this process is a racking pallet with two complementary blow moulded pieces joined together by adhesive and bolts to give a pallet as shown in FIG. 1C.

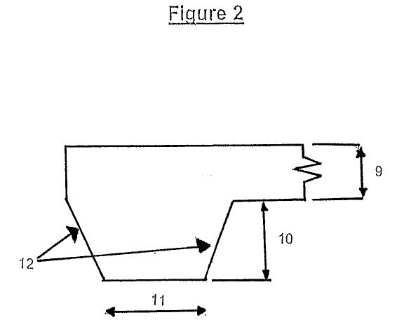

FIG. 2 shows a vertical cross section of the design of a pallet leg shape for a plastic blow moulded pallet which maintains enough wall section in the leg section of the moulding to provide sufficient strength of the pallet.

In preferred designs the underside face of the platform has nine integrated leg protrusions that form a space for a fork hoist forks.

Each of the nine legs are square or rectangular in shape and would have substantially the same proportions as shown in FIG. 2. However, the sides of the legs can be more vertical.

Requirements of the present design is that the height of each leg (10) is 100% to 300% the height of the platform (9), and that the width of the base of the leg (11) is 100% to 650% the height of the leg.

The depth of the base of the leg (when looked at in 3 dimensions, not shown) is equal to the width of the base of the leg (11). The base of the leg is therefore substantially square.

For a single piece pallet (as shown in FIG. 1A) the height of the support legs (2) is 110 mm in order to allow forklift tines to fit between the support legs in order to lift the pallet. For a double piece pallet (as shown in FIG. 1C) the height of the support legs (6) is 55 mm for each half.

In order to gain sufficient thickness of plastic in the support leg, the shape of the leg sides (12) may be angled, for example at 30° to the vertical from the platform base.

This design allows a blow moulded thermoplastic pallet to be constructed from one hollow moulding with a thin plastic skin that forms the top and bottom face of the pallet platform, to provide extra strength the hollow space if filled with structural foam, the structural foam usually being polyurethane.

For a pallet required to hold a weight of 1000 kilograms the required thickness of the plastic blow moulded skin is 1 to 8 millimeters, however if the pallet if foam filled the thickness may be reduced to 1 to 6 millimeters.

In some embodiments the legs also have indentations (13) which allow 2 complementary pallet halves to be joined together via bolts or other joining techniques

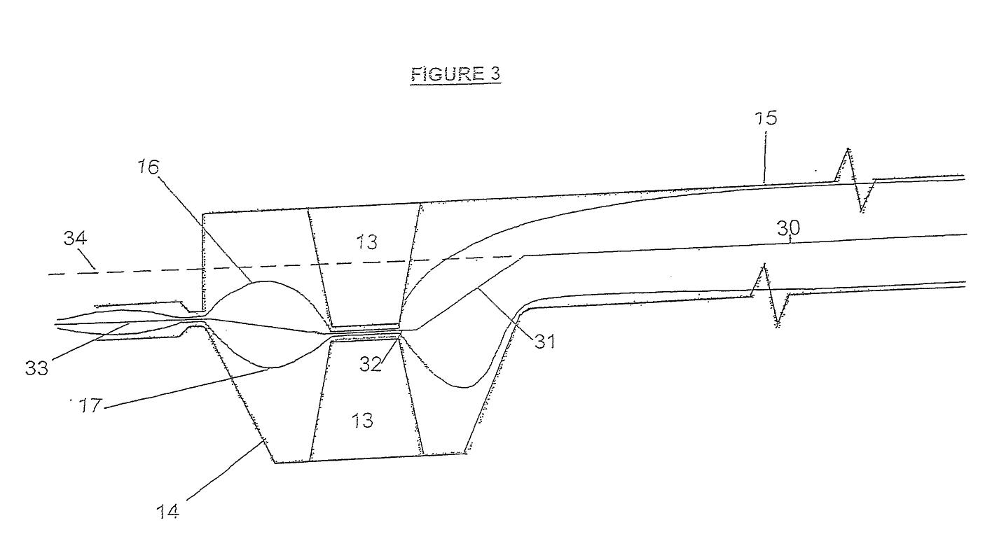

FIG. 3 shows the cross section of a pallet leg (14) and part of the platform (15). The design of the pallet is such that the two sides of the parison (16), (17) provide sufficient plastic that after blow moulding the inside of the mould is covered with a sufficient thickness of plastic to provide the required strength.

FIG. 3 also shows where the mould parting line undergoes local deviation. The deviated mould parting line is shown by (30), it passes through the centre of the platform (15) height and then angles (31) towards the base of the support leg (14), until it reaches a level approximately central to the height of the support leg (32). As FIG. 3 shows a support leg located on one edge of the pallet the parting line continues on, or angles slightly up to the side of the pallet (33). In the case of an internal support leg the parting line would angling back up to the original position in order to pass through the centre of the height of the next portion of platform. This local deviation is present at the location of each support leg. The dotted line (34) indicates where a standard mould parting line would lie.

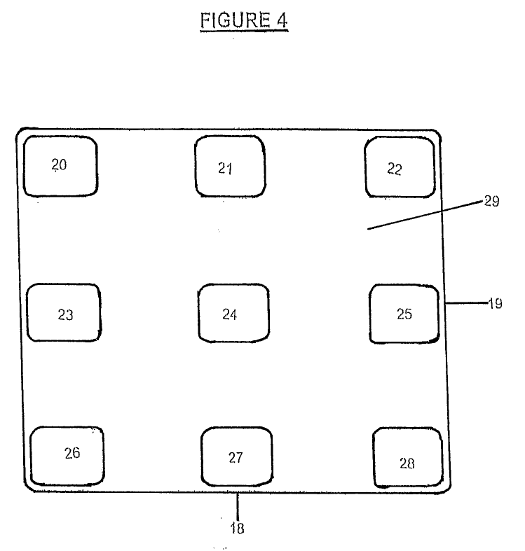

FIG. 4 shows a top view of a pallet (or pallet piece). The dimensions of the pallet in preferred embodiments is 1200 mm long (18) by 1000 mm wide (19). The dotted areas (20-28) indicate the positioning of the nine support legs in relation to the pallet platform (29)

Aspects of the present invention have been described by way of example only and it should be appreciated that modifications and additions may be made thereto without departing from the scope thereof as defined in the appended claims.

1. A method of producing a one-piece support structure which incorporates a supporting platform and at least one integral support leg using a blow moulding technique, including the steps of:
a) defining the optimum thickness of material required for the support leg(s) for strength purposes,
b) defining the optimum height for the support legs,
c) determining the volume of the parison, to be introduced across the leg part of the mould,
d) designing the mould leg interior to ensure that for the given parison volume the thickness of material subsequently blow moulded around the surface area of the support leg is sufficient to provide the required strength, and
e) blow moulding material into the mould as designed by steps a) to d).

2. The method of producing a support structure as claimed in claim 1, wherein the support structure is a pallet.

3. The method of producing a support structure as claimed in claim 2, wherein the thickness of material blow moulded around the surface area of the support legs is within the range of 1 to 10 mm for a support structure required to hold in the order of 1000 kilograms in a racking situation.

4. The method of producing a support structure as claimed in claim 2, wherein the thickness of material blow moulded around the surface area of the support legs is within the range of 1 to 6 mm for a pallet required to hold in the order of 1000 kilograms in a racking situation.

5. The method of producing a support structure as claimed in claim 1, wherein the height of the integral legs relative to the supporting platform is sufficient to allow at least one forklift tine to be positioned under the supporting platform.

6. The method of producing a support structure as claimed in claim 1, wherein the height of the integral legs is within the range of 100% to 300% of the height of the supporting platform.

7. The method of producing a support structure as claimed in claim 1, wherein the width at the base of the integral legs is between 100% and 650% of a height of integral feet.

8. The method of producing a support structure as claimed in claim 1, wherein the integral legs are angled to a narrower portion at an end distal to the supporting platform.

9. The method of producing a support structure as claimed in claim 1, wherein a mould parting line in the vicinity of the support leg deviates towards a base of the leg.

10. The method of producing a support structure as claimed in claim 1, wherein the thickness of material deposited into the integral legs and corners of the support platform are enhanced by increasing the volume of the parison introducing liquid material to these areas.

11. The method of producing a support structure as claimed in claim 1, wherein the support structure is manufactured a high density polyethylene.

12. The method of producing a support structure as claimed claim 1, wherein the support structure is formed in one piece.

13. The method of producing a support structure as claimed in claim 12, wherein the height of the support legs is within the range of 100 to 150 mm.

14. The method of producing a support structure as claimed in claim 12, wherein the height of the support legs is within the range of 100 to 110 mm.

15. The method of producing a support structure as claimed claim 1, wherein the support structure is formed in two pieces which are complementary to one another.

16. The method of producing a support structure as claimed in claim 15, wherein the two support structures pieces are joined through opposing legs on each piece.

17. The method of producing a support structure as claimed in claim 15, wherein the two support structures include at least one complementary interlocking joining portion.

18. The method of producing a support structure as claimed in claim 17, wherein the interlocking joining portion is a male/female connection.

19. The method of producing a support structure as claimed in claim 15, wherein the two complementary support structures are bolted together.

20. The method of producing a support structure as claimed in claim 15, wherein the height of the support legs is within the range of 75 to 150 mm.

21. The method of producing a support structure as claimed in claim 1, wherein the supporting platform has between three and twelve integral legs.

22. The method of producing a support structure as claimed in claim 1, wherein the interior of the blow moulded support structure is at least partially filled with a secondary material.

23. The method of producing a support structure as claimed in claim 22, wherein the secondary material is polyurethane.

24. The method of producing a support structure as claimed in claim 1, wherein the support structure also includes ribbing.

25. The method of producing a support structure as claimed in claim 24, wherein the ribbing is positioned in the gaps between the supporting legs.

26. The method of producing a support structure as claimed in claim 1, wherein the support structure also includes apertures of a size and shape that can accommodate a pallet trolley.

27. The method of producing a support structure as claimed in claim 1, wherein the support structure also includes at least one handhold.

28. The method of producing a support structure as claimed in claim 27, wherein at least one handhold is positioned on each of the sides of the support structure.

29. A support producing manufactured by the method as claimed in claim 1.

30. (canceled)

31. (canceled)
